(19) United States
(12) Patent Application Publication
(10) Pub. No.: US 2012/0243058 A1
(43) Pub. Date: Sep. 27, 2012

(54) IMAGE READING DEVICE

(75) Inventor: Yukinobu IGUCHI, Hamamatsu-shi (JP)

(73) Assignee: Konica Minolta Business Technologies, Inc., Chiyoda-ku (JP)

(21) Appl. No.: 13/424,806

(22) Filed: Mar. 20, 2012

(30) Foreign Application Priority Data
Mar. 22, 2011 (JP) 2011-062354

(51) Int. Cl. H04N 1/04

(52) U.S. Cl. 358/474

(57) ABSTRACT

An image reading device having: a light source unit for irradiating a document on a reading point; an image pick-up element for receiving light reflected from the document on the reading point; and a light absorber; wherein the light source unit comprises: a light source for emitting light; and an optical guide for guiding the light emitted from the light source and irradiating the document on the reading point with the light; wherein a prism is provided on a surface of the optical guide so as to reflect the light traveling in the optical guide to the reading point; and wherein the light absorber for absorbing light that was reflected from the document on a point different from the reading point, so that the light can be prevented from being reflected thereby and from traveling to the reading point.

This application is based on Japanese Patent Application No. 2011-062354 filed on Mar. 22, 2011, the content of which is incorporated herein by reference.

### BACKGROUND OF THE INVENTION

1. Field of the Invention

The present invention relates to an image reading device, and more particularly to an image reading device that emits light to a document and that reads the light reflected from the document to take in image data.

2. Description of Related Art

An example of conventional image reading devices is an image reading device shown by Japanese Patent Laid-Open Publication No. 2005-198106. The image reading device comprises a stick-like optical guide, LEDs and a white case.

The LEDs are disposed at both ends of the stick-like optical guide and emit light into the stick-like optical guide. The stick-like optical guide is covered by the white case, but the upper portion of the stick-like optical guide is not covered. Therefore, the light emitted from the LEDs travels in the stick-like optical guide and is emergent from the stick-like optical guide through the upper portion.

The image reading device disclosed by Japanese Patent Laid-Open Publication No. 2005-198106 has a problem that the reproducibility of an image formed from image data read thereby is low. Specifically, there are tone-level differences between the original image and an image reproduced from the read image data.

### SUMMARY OF THE INVENTION

An image reading device according to an embodiment of the present invention comprises: a light source unit for irradiating a document on a reading point; an image pick-up element for receiving light reflected from the document on the reading point; and a light absorber; wherein the light source unit comprises: a light source for emitting light; and an optical guide for guiding the light emitted from the light source and irradiating the document on the reading point with the light; wherein a prism is provided on a surface of the optical guide opposite to a surface facing the reading point so as to reflect the light traveling in the optical guide to the reading point; and wherein the light absorber, which is located to face to the prism, for absorbing light that was reflected from the document on a point different from the reading point and that passed through the prism, so that the light can be prevented from being reflected thereby and from traveling to the reading point.

### BRIEF DESCRIPTION OF THE DRAWINGS

This and other features of the present invention will be apparent from the following description with reference to the accompanying drawings, in which:

FIG. 1 is a skeleton framework of an image reading device according to an embodiment of the present invention;

FIG. 2 is a perspective view of a light source unit;

FIG. 3 is a sectional view of optical guides of the light source unit;

FIGS. 4a and 4b are sectional views of the optical guides of the light source unit;

FIG. 5 is a sectional view of optical guides of a light source unit employed in an image reading device according to a comparative example, FIG. 5 showing a flare occurrence;

FIG. 6 is a sectional view of one of the optical guides of the light source unit employed in the image reading device according to the comparative example, FIG. 6 showing a flare occurrence;

FIG. 7 is a sectional view of one of the optical guides of the light source unit employed in the image reading device according to the embodiment;

FIG. 8 is a view of a document that was used for an image reading experiment; and

FIG. 9 is a sectional view of a modified light source unit.

### DETAILED DESCRIPTION OF THE PREFERRED EMBODIMENTS

An image reading device according to an embodiment of the present invention is hereinafter described.

### Structure of the Image Reading Device

The structure of an image reading device 10 according to an embodiment of the present invention is described with reference to the accompanying drawings. FIG. 1 is a skeleton framework of the image reading apparatus 10 according to an embodiment. In the following paragraphs, the vertical direction is referred to as z direction, and the moving direction of slider sections 18 and 20 are referred to as x direction (sub-scanning direction). The direction orthogonal to the directions x and z is referred to as y direction (main-scanning direction).

The image reading device 10, as shown by FIG. 1, comprises a main body 12, a document cover 14, a platen glass 16, slider sections 18 and 20, an imaging lens 22, an image pick-up element 24 and a control unit 48.

The main body 12 is a quadratic-prismatic case in which the document cover 14, the platen glass 16, the slider sections 18 and 20, the imaging lens 22 and the image pick-up element 24 are encased. The platen glass 16 is a rectangular transparent plate that is fitted in an opening made in the main body 12 on a positive side in the z direction. A document P is placed on a main surface of the platen glass 16 with the side to be subjected to image reading facing the negative side in the z direction.

As shown in FIG. 1, the document cover 14 covers the document P and makes the document P adhere to the platen glass 16.

The slider section 18 is located in the negative side from the platen glass 16 in the z direction and is movable in the x direction. The slider section 18 comprises a light source unit 27 and a mirror 29.

The light source unit 27 emits light Ba and Bb to a reading point A on the platen glass 16 so as to irradiate the document P on the reading point A from two directions. The light source unit 27 will be described in more detail later. The reading point A is located in the positive side from the light source unit 27 in the z direction and on the platen glass 16, and with a movement of the slider section 18 in the x direction, the reading point A moves in the x direction.

The mirror 29, as shown in FIG. 1, receives the light Ba and Bb reflected from the document P on the reading point A and reflects the light Ba and Bb to the negative side in the x direction.

The slider section 20 is located in the negative side from the platen glass 16 in the z direction and is movable in the x direction. The slider section 20 comprises mirrors 30 and 32. The mirror 30 receives the light Ba and Bb from the mirror 29 and reflects the light Ba and Bb to the negative side in the z direction. The mirror 32 receives the light Ba and Bb from the mirror 30 and reflects the light Ba and Bb to the positive side in the x direction.

The imaging lens 22 receives the light Ba and Bb from the mirror 32 and focuses an optical image made by the light Ba and Bb on the image pick-up element 24. Thus, the image pick-up element 24 is a light receiving element that receives the light Ba and Bb reflected from the document P on the reading point A. More specifically, the image pick-up element 24 is a line sensor having a linear image pick-up region extending in the y direction, and the image pick-up element 24 is, for example, a CCD camera that receives optical images brought into focus by the imaging lens 22 during scanning of the document P on the linear image pick-up region, thereby reading the image of the document P.

The control unit 48 is, for example, a CPU and controls the image reading device 10.

### Structure of the Light Source Unit

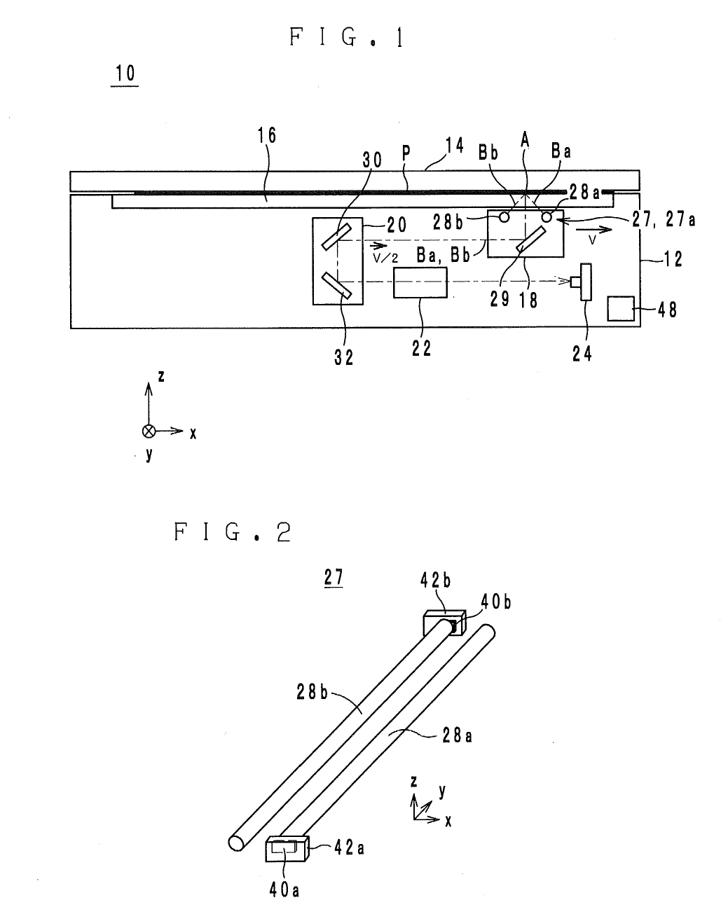

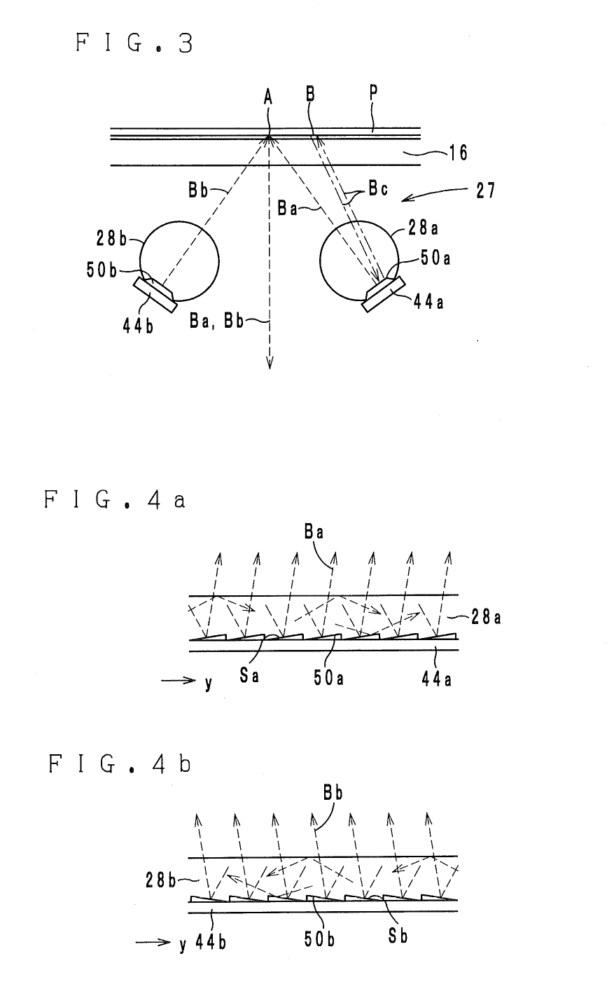

Next, the structure of the light source unit 27 is described with reference to the drawings. FIG. 2 is a perspective view of the light source unit 27. FIGS. 3, 4a and 4b are sectional views of optical guides 28a and 28b of the light source unit 27.

LEDs 40a and 40b are semiconductor elements that emit light. Circuits for driving the LEDs 40a and 40b are incorporated in substrates 42a and 42b, respectively. The LED 40a is mounted on the positive-side main surface in the y direction of the substrate 42a. The LED 40b is mounted on the negative-side main surface in the y direction of the substrate 42b.

The optical guide 28a is a cylindrical transparent resin member extending in the y direction. The LED 40a is located to face the negative-side end in the y direction of the optical guide 28a. Thereby, the light emitted from the LED 40a enters into the optical guide 28a through the negative-side end in the y direction thereof. As shown in FIGS. 3 and 4a, the optical guide 28a guides the light emitted from the LED 40a to the positive side in the y direction. Also, the optical guide 28a irradiates the document P on the reading point A with the light emitted from the LED 40a. For this purpose, as shown in FIGS. 3 and 4a, a prism 50a is provided on the surface of the optical guide 28a opposite to the surface facing the reading point A so as to reflect the light guided in the optical guide 28a to the reading point A. Specifically, the prism 50a is formed of surfaces Sa that are inclined to the negative side in the y direction and that are aligned in the y direction. The light Ba reflected by the inclined surfaces Sa of the prism 50a is emergent from the optical guide 28a and hits the document P on the reading point A from the positive side in the x direction.

The optical guide 28b is a cylindrical transparent resin member extending in the y direction and is located in the negative side from the optical guide 28a in the x direction. The LED 40b is located to face the positive-side end in the y direction of the optical guide 28b. Thereby, the light emitted from the LED 40b enters into the optical guide 28b through the positive-side end in the y direction thereof. As shown in FIGS. 3 and 4b, the optical guide 28b guides the light emitted from the LED 40b to the negative side in the y direction. Also, the optical guide 28b irradiates the document P on the reading point A with the light emitted from the LED 40b. For this purpose, as shown in FIGS. 3 and 4b, a prism 50b is provided on the surface of the optical guide 28b opposite to the surface facing to the reading point A so as to reflect the light guided in the optical guide 28b to the reading point A. Specifically, the prism 50b is formed of planes Sb that are inclined to the positive side in the y direction and that are aligned in the y direction. The light Bb reflected by the inclined surfaces Sb of the prism 50b is emergent from the optical guide 28b and hits the document P on the reading point A from the negative side in the x direction.

Further, the image reading device 10 comprises black sheets 44a and 44b as shown in FIGS. 3, 4a and 4b. The black sheets 44a and 44b are light absorbers. The black sheets 44a and 44b are located to face the surfaces on which the prisms 50a and 50b are provided, respectively. In the image reading device 10, the black sheets 44a and 44b are in contact with the surfaces on which the prisms 50a and 50b are provided, respectively.

### Operation of the Image Reading Device

Now, the operation of the image reading device 10 is described with reference to FIG. 1.

For image reading of a document P, the document P is placed on the main surface of the platen glass 16 and is pressed against the platen glass 16 by the document cover 14. During the image reading of the document P, as shown by FIG. 1, the slider section 18 is moved along the platen glass 16 to the positive side in the x direction at a speed V by a driving mechanism comprising a motor, a belt, a pulley and the like (not shown).

Meanwhile, during the image reading of the document P, the slider section 20 is moved to the positive side in the x direction at a speed V/2 within the negative side of the platen glass 16 in the z direction by a driving mechanism comprising a motor, a belt, a pulley and the like (not shown). The arrangement of moving the slider section 20 at a half speed of the slider section 18 permits the optical path length between the read surface of the document P and the image pick-up element 24 to be kept constant during the movements of the slider sections 18 and 20.

Thus, by the movement of the slider section 18 in the x direction, the document P is scanned in the x direction, and the image pick-up element 24 reads the whole image data of the document P.

### Advantage

By using the image reading device 10 according to this embodiment, it becomes possible to form an image with high reproducibility. Specifically, the present inventors found out that the reproducibility of an image formed from image data read by the image reading device disclosed by Japanese Patent Laid-Open Publication No. 2005-198106 was low, and more particularly the inventors found out that there were tone-level differences between the original image and an image reproduced from the read image data.

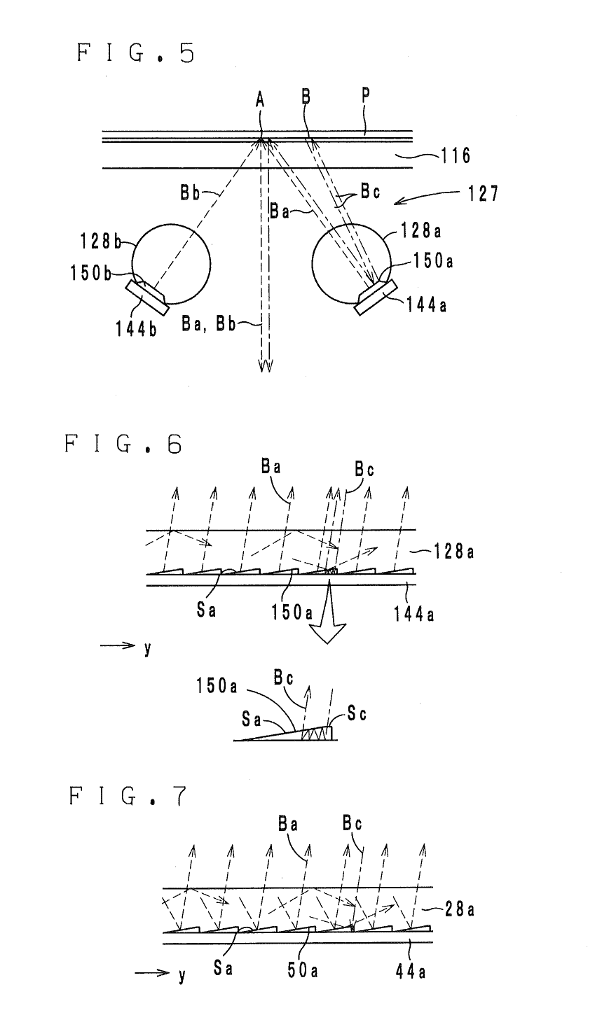

After studying the causes of the low reproducibility, the inventors reached a conclusion that flare is a cause of the low reproducibility. In the following, the flare is described in connection with an image reading device of a comparative example. FIGS. 5 and 6 are to show a flare occurrence, and FIGS. 5 and 6 are sectional views of optical guides 128a and 128b of a light source unit employed in the image reading device of the comparative example. FIG. 7 is a sectional view of the optical guide 28a of the light source unit 27. In the image reading device of the comparative example, white sheets 144a and 144b are provided in the optical guides 128a and 128b, respectively.

As shown in FIGS. 5 and 6, the light emitted from the optical guide 128a mostly travels to the reading point A as shown by Ba and Bb, but the light emitted from the optical guide 128a partly travels to a point B away from the reading point A as shown by Bc. The light component Bc may enter into the optical guide 28a again after reflected from the document P on the point B.

As shown in FIG. 6, the prism 150a comprises inclined surfaces Sa and flat surfaces Sc. Each flat surface Sc, which is parallel to the y direction, is located adjacently at the positive side of each inclined surface Sa in the y direction. It is preferred that the flat surfaces Sc do not exist in the prism 150a, but the flat surfaces Sc are formed due to insufficiency of processing accuracy in producing the prism 150a. Then, since the flat surfaces Sc exist, it is likely that the light component Bc that was reflected from the document P on the point B to the optical guide 128a, as shown by FIG. 6, may enter in between the inclined surface Sa and the white sheet 144a. In this case, then, the light component Bc is reflected between the inclined surface Sa and the white sheet 144a repeatedly and then, may enter into the optical guide 128a again. Thereafter, as shown by FIG. 5, the light component Bc may hit the document P on the reading point A and may enter into the image pick-up element 24 together with the light components Ba and Bc. The light component Bc that enters into the image pick-up element 24 after hitting a point B different from the reading point A and reflected therefrom, as described above, is called flare.

The intensity of the light component Bc, which is flare, varies in accordance with the density of the point B. For example, when different points A1 and A2 on the document P are subjected to image reading, the points B1 and B2, respectively, are irradiated with the light component Bc. Here, the points A1 and A2 have the same density, and the points B1 and B2 have different densities. In this case, the intensity of the light component Bc for reading of the point A1 is different from the intensity of the light component Bc for image reading of the point A2, and the total intensity of the light components Ba, Bb and Be entering into the image pick-up element 24 for image reading of the point A1 is different from the total intensity of the light components Ba, Bb and Bc for image reading of the point A2. Consequently, although the points A1 and A2 actually have the same density, the points A1 and A2 are not read to have the same density because the points B1 and B2 have different densities. Therefore, the reproducibility of an image formed from image data read by use of the image reading device of the comparative example is low. For the same reason, the image reading device disclosed by Japanese Patent Laid-Open Publication No. 2005-198106 has a problem that the reproducibility of an image formed by use thereof is low.

In order to solve this problem, the image reading device 10 employs the black sheets 44a and 44b instead of the white sheets 144a and 144b. The black sheets 44a and 44b absorb the light Bc that was reflected from the point B different from the reading point A and reaches thereto, so that the light Bc is prevented from traveling to the reading point A. More specifically, as shown by FIG. 7, the light Bc that was reflected from the document P on the point B different from the reading point A and enters in between the inclined surface Sa and the black sheet 44a and in between the inclined surface Sb and the black sheet 44b via the flat surfaces Sc is absorbed by the black sheets 44a and 44b. Therefore, there is no possibility that the light Bc may enter into the optical guides 28a and 28b again, and flare is prevented. Consequently, the reproducibility of an image formed by use of the image reading device 10 is higher than the reproducibility of an image formed by use of the image reading device of the comparative example.

In the image reading device 10, the black sheets 44a and 44b are in contact with the surfaces on which the prisms 50a and 50b are provided, respectively. Therefore, the light Bc can be absorbed by the black sheets 44a and 44b more effectively.

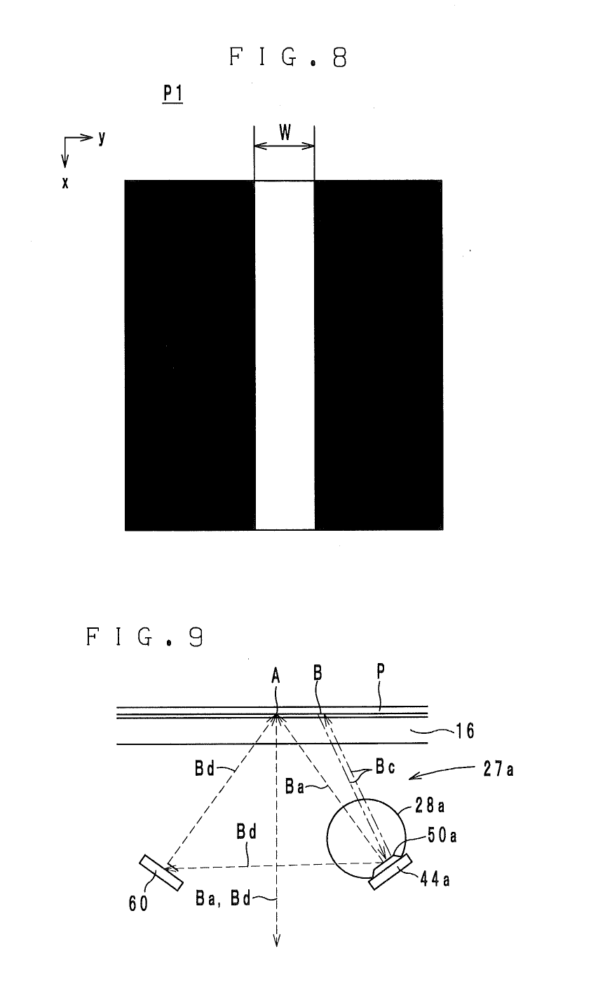

The inventors conducted an experiment so as to prove that the image reading device 10 has the above-described advantage. FIG. 8 shows a document P1 that was used in the experiment. In the document P1, there was a white stripe extending in the y direction on a black background. The white stripe had a width W.

First, the inventors fabricated the image reading device of the comparative example as a first sample and the image reading device 10 as a second sample. Then, the inventors performed image reading of the document P1 as shown by FIG. 8 and image reading of a document P2 with a wholly white image by use of the first sample and the second sample. In the experiment, while the width W of the white stripe on the document P1 was varied, the image of the document P1 was read by the first sample and the second sample, and changes in output tone level which the samples read as the tone level of the white stripe were examined. Table 1 shows the results of the experiment. In the first and the second samples, 256 tone levels are readable. The higher the tone level, the whiter, and the lower the tone level, the blacker.

TABLE 1

| | First Sample | | | Second Sample | | |
|---|---|---|---|---|---|---|
| W | | | Rate of | | | Rate of |
| (mm) | P2 | P1 | Difference (%) | P2 | P1 | Difference (%) |
| 2 | 248 | 184 | 26.0 | 240 | 211 | 11.9 |
| 4 | 248 | 191 | 23.0 | 240 | 219 | 8.9 |
| 7 | 248 | 198 | 20.3 | 240 | 224 | 6.7 |
| 10 | 248 | 205 | 17.3 | 240 | 227 | 5.5 |
| 15 | 248 | 212 | 14.7 | 240 | 231 | 3.9 |
| 20 | 248 | 218 | 12.1 | 240 | 233 | 2.9 |
| 30 | 248 | 225 | 9.4 | 240 | 235 | 2.1 |
| 45 | 248 | 233 | 6.3 | 240 | 239 | 0.6 |
| 60 | 248 | 240 | 3.5 | 240 | 238 | 0.6 |
| 80 | 248 | 244 | 1.9 | 240 | 239 | 0.3 |
| 100 | 248 | 246 | 1.1 | 240 | 242 | −0.7 |

As shown in Table 1, the first sample read the white stripe having a width W of 2 mm on the document P1 as a tone level of 184 and read the white stripe having a width W of 100 mm as a tone level of 246. The first sample read the white image on the document P2 as a tone level of 248. Thus, when the width W of the white stripe on the document P1 was small, there was a large difference between the tone level outputted from the first sample as the tone level of the white stripe on the document P1 and the tone level outputted from the first sample as the tone level of the white image on the document P2, and when the width W of the white stripe on the document P1 was large, there was a small difference between the tone level outputted from the first sample as the tone level of the white stripe on the document P1 and the tone level outputted from the first sample as the tone level of the white image on the document P2. This shows that when the width W of the white stripe was large, flare occurred relatively to a great extent, whereas when the width W of the white stripe was small, flare occurred to a small extent. Hence, the first sample reads the same white portion as different tone levels, depending on the density of the surrounding portions.

On the other hand, the second sample read the white stripe having a width W of 2 mm on the document P as a tone level of 211 and the white stripe having a width W of 100 mm as a toner level of 242. The second sample read the white image on the document P2 as a tone level of 240. Thus, when the second sample was used for image reading, the difference between the outputted tone level as the tone level of the white stripe on the document P1 and the outputted tone level as the tone level of the white image on the document P2 did not vary so largely depending on the width W of the white stripe on the document P1 as that when the first sample was used for image reading. This means that flare was suppressed even when the width W of the white stripe was large. Hence, the results of the experiment show that flare occurrences can be suppressed in the image reading device 10, resulting in an improvement in reproducibility of an image.

### MODIFICATIONS

Next, a modified light source unit 27a is described with reference to the drawings. FIG. 9 is a sectional view of the modified light source unit 27a.

As described above, the light source unit 27 comprises optical guides 28a and 28b, LEDs 40a and 40b and substrates 42a and 42b. However, the modified light source unit 27a comprises an optical guide 28a, an LED 40a and a substrate 42a but does not comprise the optical guide 28b, the LED 40b and the substrate 42b. Instead, the modified light source unit 27a comprises a mirror 60. The mirror 60 reflects light Bd emergent from the optical guide 28a to the document P on the reading point A. Thereby, although the optical guide 28b, the LED 40b and the substrate 42b are not provided in the light source unit 27a, it is possible to irradiate the document P from two directions.

In the image reading device 10, the black sheets 44a and 44b need not necessarily be in contact with the surfaces on which the prisms 50a and 50b are provided, respectively. The black sheets 44a and 44b may be arranged in any positions to absorb the light Bc so as to prevent the light Be from traveling to the reading point A. Therefore, the black sheets 44a and 44b are merely required to face the prisms 50a and 50b, respectively.

In the image reading device 10, the black sheets 44a and 44b, which serve as light absorbers, need not necessarily be black. The sheets 44a and 44b are required to have a lower reflectance than white, and therefore, the sheets to serve as light absorbers may be gray or the like.

Further, it is preferred that no reflecting members are provided around the optical guides 28a and 28b so as to prevent flare occurrences.

Although the present invention has been described in connection with the preferred embodiments above, it is to be noted that various changes and modifications are possible to those who are skilled in the art. Such changes and modifications are to be understood as being within the scope of the present invention.

What is claimed is:

1. An image reading device comprising:
a light source unit for irradiating a document on a reading point;
an image pick-up element for receiving light reflected from the document on the reading point; and
a light absorber;
wherein the light source unit comprises:
a light source for emitting light; and
an optical guide for guiding the light emitted from the light source and irradiating the document on the reading point with the light;
wherein a prism is provided on a surface of the optical guide opposite to a surface facing the reading point so as to reflect the light traveling in the optical guide to the reading point; and
wherein the light absorber, which is located to face the prism, for absorbing light that was reflected from the document on a point different from the reading point and that passed through the prism, so that the light can be prevented from being reflected thereby and from traveling to the reading point.

2. An image reading device according to claim 1, wherein the light absorber is in contact with the surface on which the prism is provided.

3. An image reading device according to claim 1, wherein the light absorber has a reflectance lower than that of white.

4. An image reading device according to claim 3, wherein the light absorber is black.

5. An image reading device according to claim 1,
wherein the optical guide extends in a main-scanning direction; and
wherein the light emitted from the light source enters into the optical guide through one end thereof.
